(19) United States
(12) Patent Application Publication
(10) Pub. No.: US 2015/0281075 A1
(43) Pub. Date: Oct. 1, 2015

(54) METHOD AND APPARATUS FOR PROCESSING ADDRESS RESOLUTION PROTOCOL (ARP) PACKET

(71) Applicant: Electronics and Telecommunications Research Institute, Daejeon (KR)

(72) Inventors: Soo Myung PARK, Daejeon (KR); Sun Me KIM, Daejeon (KR); Tae Il KIM, Daejeon (KR); Sung Hyuk BYUN, Daejeon (KR); Chang Gyu LIM, Daejeon (KR)

(21) Appl. No.: 14/664,381

(22) Filed: Mar. 20, 2015

(30) Foreign Application Priority Data
Mar. 31, 2014 (KR) 10-2014-0037782

(51) Int. Cl. H04L 12/741; H04L 12/66; H04L 12/947

(52) U.S. Cl. CPC H04L 45/745; H04L 49/25; H04L 12/66

(57) ABSTRACT

A method and apparatus for processing an address resolution protocol (ARP) packet that searches, with respect to an ARP packet received from an end system, for a media access control (MAC) address of another end system indicated by the received ARP packet, transmits a proxy response packet to the end system that transmits an ARP packet using the found MAC address, and thus reduces an overload of a Layer 3 (L3) network through the proxy response packet being transmitted to the end system that transmits the ARP packet is provided.

### CROSS-REFERENCE TO RELATED APPLICATION

This application claims the priority benefit of Korean Patent Application No. 10-2014-0037782, filed on Mar. 31, 2014, in the Korean Intellectual Property Office, the disclosure of which is incorporated herein by reference.

### BACKGROUND

1. Field of the Invention

Embodiments of the present invention relate to a method and an apparatus for processing an address resolution protocol (ARP) packet, and more particularly, to a method and an apparatus for processing an ARP packet that reduces an overload of a Layer 3 (L3) network occurring due to flooding of an ARP packet.

2. Description of the Related Art

In an environment of a virtual extensible local area network (VxLAN), a Layer 2 (L2) network may be extended via a VxLAN network identifier (VNI).

A system based on a VxLAN network may include at least one VxLAN tunnel end point (VTEP). Each of the at least one VTEP may be included as a VTEP module to function as a VTEP in a gateway switch.

An end system may communicate with the VTEP module through a bridge domain of the gateway switch. The VTEP module may transmit a packet received from a request end system to a target end system.

A media access control (MAC) address of the target end system needs to be obtained to allow the request end system of the gateway switch to communicate with the target end system of another gateway switch. The request end system may transmit a multicast-based or broadcast-based ARP packet to the target end system to obtain the MAC address of the target end system.

For example, a large number of ARP packets needs to be transmitted via a Layer 3 (L3) network because each end system of the gateway switch needs to obtain an MAC address of all other end systems with which the each end system desires to communicate. When the large number of ARP packets are transceived via the L3 network, an overload of the L3 network may increase. Further, the overload of the L3 network may lead to a delay in updating of an ARP table for the each end system, and correspondingly, communication to amongst the end systems may also experience a delay.

Accordingly, there is a need for a method of processing an ARP packet that reduces the overload of the L3 network occurring due to flooding of the ARP packet in the L3 network while efficiently managing MAC addresses and IP addresses of the end systems.

The aforementioned description is provided to assist the reader in gaining a comprehensive understanding of the methods, apparatuses, and/or systems described herein, and may include content that does not form part of the related art. Also, descriptions of functions and constructions that are well known to one of ordinary skill in the art may be omitted for increased clarity and conciseness.

### SUMMARY

An aspect of the present invention provides a method and an apparatus for processing an address resolution protocol (ARP) packet that searches, with respect to an ARP packet received from an end system, for a media access control (MAC) address of another end system indicated by the received ARP packet, and transmits a proxy response packet to the end system that transmits the ARP packet using the found MAC address.

Another aspect of the present invention also provides a method of managing a network connection information database by receiving network connection information of end systems from gateway switches and/or a cloud network management system.

According to an aspect of the present invention, there is provided a method of processing an ARP packet performed by a gateway switch, the method including receiving an ARP packet from an end system of the gateway switch, searching for an MAC address of another end system that the end system desires to obtain through the received ARP packet, and transmitting a proxy response packet with respect to the ARP packet to the end system when the MAC address of the other end system is found.

The searching may include searching for the MAC address based on a network connection information database of the gateway switch.

The gateway switch may be connected to at least one gateway switch and a cloud network management system via a network, and the network connection information database is a database of a network connection information divided based on a network identifier of at least one other end system of the cloud network management system or at least one other end system of the gateway switch.

The gateway switch may be connected to at least one gateway switch and a cloud network management system via a network, and the network connection information database comprises at least one of an MAC address and an Internet protocol (IP) address of the cloud network management system or at least one other end system of the gateway switch.

The gateway switch may be connected to at least one gateway switch and a cloud network management system via a network, and further include transmitting a request message requesting first network connection information to the cloud network management system or at least one other gateway switch from among the at least one gateway switch, receiving the first network connection information from the other gateway switch or the cloud network management system to which the request message is transmitted, and updating the network connection information database based on the received first network connection information.

The transmitting of the request message and the receiving of the first network connection information may be performed through a multicast tunnel or a unicast tunnel.

The request message may include second network connection information of at least one end system of the gateway switch.

The method of processing the ARP packet may further include receiving third network connection information of the end system from the end system, and updating the network connection information database based on the received third network connection information.

The third network connection information may be a link layer discovery protocol (LLDP) packet transmitted through an LLDP.

An ARP table of the end system may be updated based on the transmitted proxy response packet.

The ARP packet may be a broadcast-based packet used to obtain the MAC address of the other end system with which the end system desires to communicate.

An aspect of the present invention provides a method of managing a network connection information database performed by a gateway switch connected to at least one gateway switch and a cloud network management system via a network, the method including transmitting a request message requesting first network connection information to the cloud network management system or at least one other gateway switch from among the at least one gateway switch, wherein the first network connection information comprises at least one of an MAC address and an IP address of the cloud network management system or at least one other end system of the gateway switch, receiving the first network connection information from the cloud network management system or the gateway switch to which the request message is transmitted, and updating a network connection information database of the gateway switch based on the received first network connection information, wherein the network connection information database is used to search for an MAC address of another end system that the end system desires to obtain through an ARP packet received from the end system of the gateway switch.

The transmitting of the request message and the receiving of the first network connection information may be performed through a multicast tunnel or a unicast tunnel.

The request message may include second network connection information of at least one end system of the gateway switch.

The method of managing the network connection information database may further include receiving third network connection information of the end system from at least one end system of the gateway switch, wherein the updating of the network connection information database includes updating the network connection information database based on the received first network connection information and the received third network connection information.

An aspect of the present invention provides a gateway switch including a bridge domain to receive an ARP packet from an end system of the gateway switch, and a virtual extensible local area network tunnel end point (VTEP) module to search for an MAC address of another end system that the end system desires to obtain through the received ARP packet, wherein when the MAC address of the other end system is found, the VTEP module transmits a proxy response packet with respect to the ARP packet to the end system through the bridge domain.

The gateway switch may be connected to at least one gateway switch and a cloud network management system via a network, and the VTEP module searches for the MAC address based on a network connection information database of the gateway switch, transmits a request message requesting first network connection information to the cloud network management system or at least one other gateway switch from among the at least one gateway switch, and receives the first network connection information from the other gateway switch or the cloud network management system to which the request message is transmitted, and the gateway switch further comprises an address management module to update the network connection information database based on the received first network connection information.

The gateway switch may further include an LLDP module, wherein the LLDP module receives third network connection information of the end system from the end system through the bridge domain, and the address management module updates the network connection information database based on the received third network connection information.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system including gateway switches and end systems according to a related art;

FIG. 2 is a diagram illustrating a method of transceiving packets amongst end points according to a related art;

FIG. 3 is a diagram illustrating a system including gateway switches and end systems according to an embodiment of the present invention;

FIG. 4 is a diagram illustrating a gateway switch according to an embodiment of the present invention;

FIG. 5 is a flowchart illustrating a method of processing an address resolution protocol (ARP) packet according to an embodiment of the present invention;

FIG. 6 is a flowchart illustrating a method of updating a network connection information database according to an embodiment of the present invention; and

FIG. 7 is a flowchart illustrating a method of updating a network connection information database according to an example of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures. In the following description of example embodiments, unless otherwise indicated, a term a “tunnel end point (TEP)” may refer to a “virtual extensible local area network tunnel end point (VTEP)”. For example, the terms “TEP” and “VTEP” are interchangeably used herein.

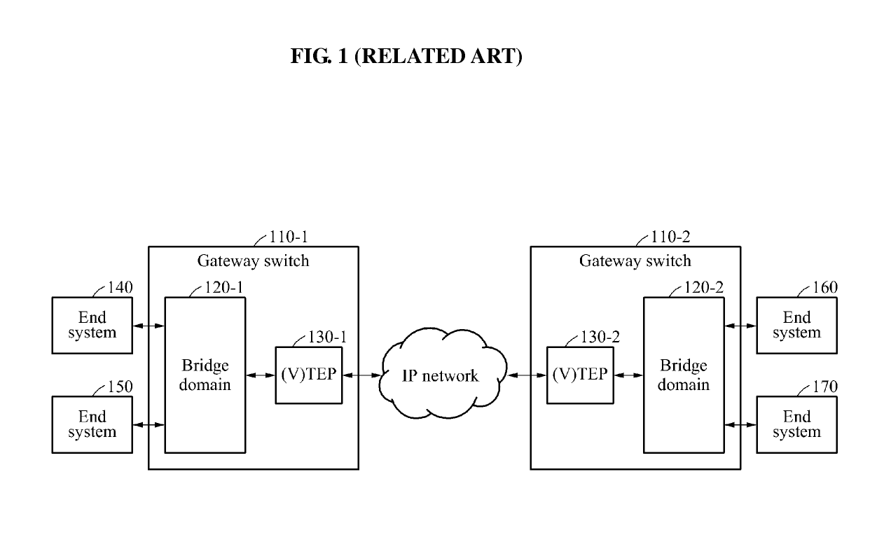

FIG. 1 is a diagram illustrating a system including gateway switches 110-1 and 110-2 and end systems 140 through 170 according to a related art.

Referring to FIG. 1, the system includes the at least one gateway switch 110-1 and 110-2 and the end systems 140 through 170. The system is based on a virtual extensible local area network (VxLAN).

The gateway switches 110-1 and 110-2 are connected via a network. For example, the gateway switches 110-1 and 110-2 are connected via an Internet protocol (IP) network.

The IP network may refer to a Layer 3 (L3) network. Each of the gateway switches 110-1 and 110-2 may be a VxLAN gateway switch.

The gateway switch 110-1 is connected to the end systems 140 and 150 via a network, and the gateway switch 110-2 is connected to the end systems 160 and 170 via a network. For example, the gateway switches 110-1 and 110-2 are connected to the end systems 140 through 170, respectively, via a Layer 2 (L2) network. Each of the end systems 140 through 170 may be a physical server or a virtual machine of the physical server. The L2 network may refer to a tenant network used by a tenant, for example, a grouped end system, as a network.

Each of the end systems 140 through 170 includes a VxLAN network identifier (VNI). The end systems 140 through 170 are grouped based on the VNI for each of the end systems 140 through 170. For example, the end systems 140 and 160 may have an identical VNI from among the end systems 140 through 170. Alternatively, the remaining end systems 150 and 170 may have an identical VNI. The VNI of the end systems 140 and 160 may differ from the VNI of the end systems 150 and 170.

The end systems 140 through 170 may be grouped into at least one multicast group based on the VNI. For example, end systems having an identical VNI have an identical multicast address.

The gateway switch 110-1 includes a bridge domain 120-1 and a VTEP module 130-1. The gateway switch 110-2 includes a bridge domain 120-2 and a VTEP module 130-2. to The gateway switch 110-1 may be identical to or similar to the gateway switch 110-2. For example, constituents of the gateway switch 110-1 correspond to constituents of the gateway switch 110-2, respectively. The end systems 140 through 170 may be identical to or similar to one another and thus, repeated descriptions will be omitted for conciseness.

The VTEP module 130-1 and the VTEP module 130-2 communicate with each other via an IP network. For example, the VTEP module 130-1 and the VTEP module 130-2 transceive a packet via the IP network.

The VTEP module 130-1 manages, through an instruction, at least one of VNI information associated with a port or a virtual LAN (VLAN) interface of the bridge domain 120-1, an IP address of a VTEP, and multicast tunnel information of a multicast group divided based on a VNI, for example, a multicast address assigned to the multicast group.

The end systems 140 and 150 communicate with the VTEP module 130-1 through the bridge domain 120-1. For example, the end systems 140 and 150 and the VTEP module 130-1 transceive a packet through the bridge domain 120-1.

For example, the bridge domain 120-1 includes a trunk interface of the gateway switch 120-1. The bridge domain 120-1 includes an interface to function as an IP host of apparatuses connected via the L3 network, for example, the IP network.

Each of the end systems 140 through 170 includes an address resolution protocol (ARP) table.

A media access control (MAC) address of a predetermined target end system needs to be obtained to allow a predetermined request end system to communicate with the target end system amongst the end systems 140 through 170.

The request end system obtains an MAC address corresponding to an IP address of the target end system using the ARP table. When the request end system does not obtain the MAC address of the target end system, the request end system transmits an ARP packet to the target end system to obtain the MAC address of the target end system. The target end system responds by a response ARP packet in response to the received ARP packet. The request end system obtains the MAC address of the target end system and the ARP table of the request end system is updated by receiving the response ARP packet from the target end system.

For example, when the end system 140 is a request end system and the end system 160 is a target end system, the end system 140 transmits an ARP packet to the VTEP module 130-1. The VTEP module 130-1 transmits the received ARP packet to the end system 160 by transmitting the ARP packet to the VTEP module 130-2 via the L3 network. Similarly, a response ARP packet in response to the ARP packet is transmitted to the VTEP module 130-2 from the end system 160, and the transmitted response ARP packet is transmitted to the end system 140 through being transmitted to the VTEP module 130-1 via the L3 network.

The ARP packet and/or the response ARP packet are transmitted through a multicast or a broadcast. Accordingly, the greater a number of a gateway switches, the greater an overload to be applied to the L3 network.

The gateway switch 110-1 includes a network connection information database including MAC addresses of the end systems 140 through 170. When an ARP packet is received from the end system 140, the VTEP module 130-1 searches for an MAC address of the end system 160 based on the network connection information database. When the MAC address of the end system 160 is found, the VTEP module 130-1, in lieu of the end system 160, transmits a proxy response packet to the end system 140. Through this, the ARP packet or a response ARP packet is not flooded via the L3 network, and thus an overload of the L3 network may be reduced.

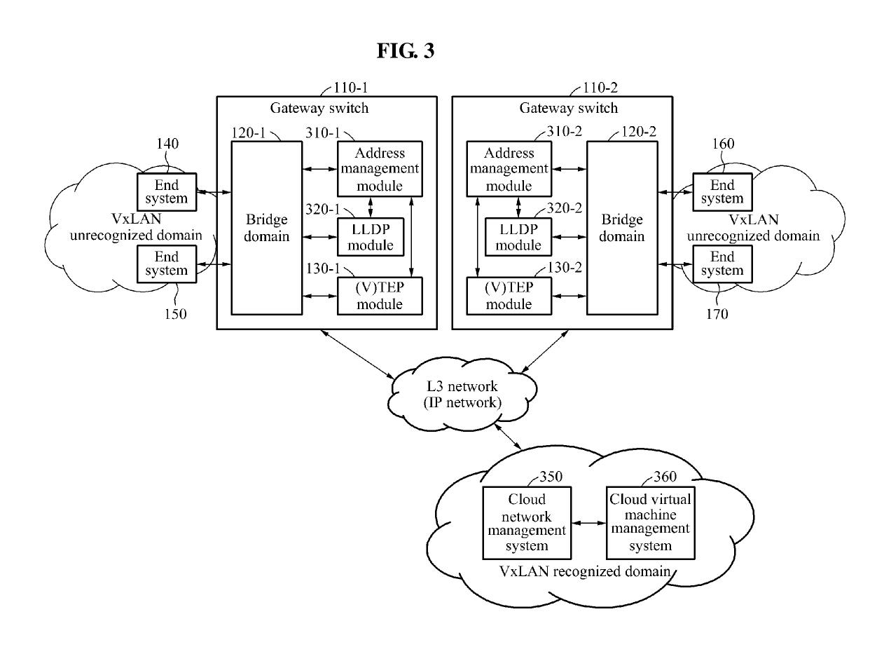

Descriptions pertaining to a method of processing the ARP packet by the gateway switch 110-1 and the network connection information database of the gateway switch 110-1 will be provided further with reference to FIGS. 3 through 7.

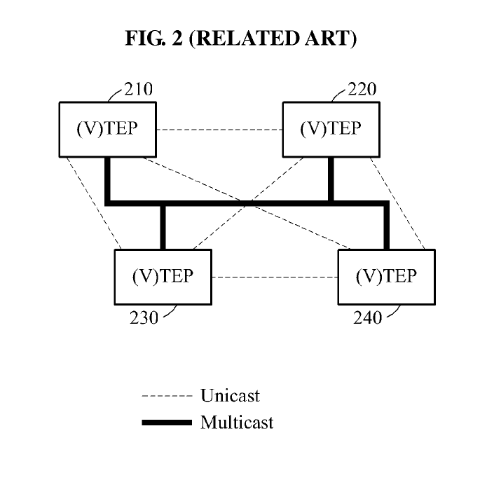

FIG. 2 is a diagram illustrating a method of transceiving packets amongst end points according to a related art.

Referring to FIG. 2, each of VTEPs 210 through 240 corresponds to the VTEP module 130-1 or 130-2 previously described with reference to FIG. 1.

Each of the VTEPs 210 through 240 communicates with the other remaining VTEPs amongst the VTEPs 210 through 240 based on at least one of a unicast method, a broadcast method, and a multicast method. For example, each of the VTEPs 210 through 240 communicates with the other remaining VTEPs amongst the VTEPs 210 through 240 using at least one of the unicast method, the broadcast method, and the multicast method based on a type of traffic and/or a type of packets to be transceived between two parties.

For example, in an instance in which the VTEP 210 is connected to a request end system and the VTEP 240 is connected to a target end system, when the request end system is aware of an IP address and an MAC address of the target end system, a packet input to the VTEP 210 through a port or a VLAN interface of a bridge domain of the VTEP 210 is set with a VxLAN header and VNI information based on the IP address and the MAC address of the target end system. The packet set with the VxLAN header and the VNI information is transmitted to the VTEP 240 through a unicast tunnel. The VTEP 240 that receives the packet removes the VxLAN header of the packet, and based on the VNI information of the packet, transmits the packet to the corresponding target end system through a port or a VLAN interface of a bridge domain. However, when the request end system is unaware of the IP address and the MAC address of the target end system or a target IP address of a packet input to the VTEP 210 is a broadcast or a multicast, the packet input to the VTEP 210 is set with a VxLAN header based on a multicast group corresponding to a VNI of a port used in the inputting of the packet, the request end system, or a VLAN interface. The packet set with the VxLAN header is transmitted to the other VTEPs 220, 230, and 240 through a broadcast tunnel or a multicast tunnel. When the packet transmitted to the other VTEPs 220, 230, and 240 corresponds to an ARP packet, the VTEP 240 connected to the target end system receives a response ARP packet from the target end system, and transmits the received response ARP packet to the VTEP 210 through a unicast tunnel. The VTEP 210 transmits the response ARP packet to the request end system, and an ARP table of the request end system is updated based on the transmitted response ARP packet.

The VxLAN header of the transmitted packet is set through IP/user datagram protocol (UDP) encapsulation.

When the request end system is unaware of the IP address and the MAC address of the target end system, the VTEP 210 obtains the MAC address of the target end system by searching for the MAC address of the target end system based on a network connection information database of a gateway switch. When the MAC address of the target end system is obtained, the VTEP 210, in lieu of the target end system, transmits a proxy response packet to the request end system. An ARP table of the request end system is updated based on the transmitted proxy response packet.

Descriptions pertaining to the method of processing the ARP packet by the gateway switch 110-1 and the network connection information database of the gateway switch 110-1 will be provided further with reference to FIGS. 3 through 7.

Since the technical features described with reference to FIG. 1 may be directly applicable here, a detailed description will be omitted for conciseness.

FIG. 3 is a diagram illustrating a system including gateway switches 110-1 and 110-2 and end systems 140 through 170 according to an embodiment of the present invention.

The system illustrated in FIG. 3 corresponds to the system including the gateway switches 110-1 and 110-2 and the end systems 140 through 170 previously described with reference to FIG. 1.

Referring to FIG. 3, the end systems 140 through 170 of the gateway switches 110-1 and 110-2 are end systems in a VxLAN unrecognized domain.

A cloud network management system 350 and a cloud virtual machine management system 360 are systems in a VxLAN recognized domain.

The end systems 140 and 150 communicate with an end system of the VxLAN recognized domain or the end systems 160 and 170 of the gateway switch 110-2 through the gateway switch 110-1.

The gateway switch 110-1 is connected to at least one gateway switch and the cloud network management system 350 via a network. For example, the gateway switch 110-1 is connected to the cloud network management system 350 of the VxLAN recognized domain or the gateway switch 110-2 via an L3 network through being connected to an external router of an Internet data center (IDC) network or an enterprise network.

The end system 140 or 150 is connected to the bridge domain 120-1 through a port or a VLAN interface of the gateway switch 110-1.

The bridge domain 120-1 has an association with end systems, for example, at least one VxLAN segment. The bridge domain 120-1 is classified based on a VNI of the at least one end system.

In the VxLAN recognized domain, a physical server of an end system includes a virtual switch to function as a VTEP. The end system in the VxLAN recognized domain is managed by the cloud network management system 350 and the cloud virtual machine management system 360.

VTEP modules of the gateway switches 110-1 and 110-2 and the cloud network management system 350 manage end systems based on a VNI for each of the end systems.

A packet transmitted by an end system is transmitted to a bridge domain and a VTEP module through a port or a VLAN interface of a gateway switch connected to the end system.

Also, the packet is transmitted to another VTEP through a unicast tunnel or a multicast tunnel path.

The gateway switch 110-1 of FIG. 3 further includes an address management module 310-1 and a link layer discovery protocol (LLDP) 320-1 when compared to the gateway switch 110-1 previously described with reference to FIG. 1.

The address management module 310-1 manages an MAC address and/or an IP address of the end systems 140 and 150 of the gateway switch 110-1. The address management module 310-1 manages network connection information of the end systems 160 and 170 and end systems of the cloud network management system 350 received by the VTEP module 130-1.

The LLDP module 320-1 receives the network connection information from the end systems 140 and/or 150 through the bridge domain 120-1.

The address management module 310-1 manages the network connection information of the end systems 140 and/or 150 received by the LLDP module 320-1. The network connection information of the end systems managed by the address management module 310-1 includes MAC addresses and/or IP addresses of the end systems.

The network connection information is managed by the address management module 310-1 through being stored in a network connection information database to be described later.

The network connection information of the end systems of the cloud network management system 350 is managed by the cloud virtual machine management system 360. For example, the cloud virtual machine management system 360 of the cloud network management system 350 corresponds to the address management module 310-1 of the gateway switch 110-1.

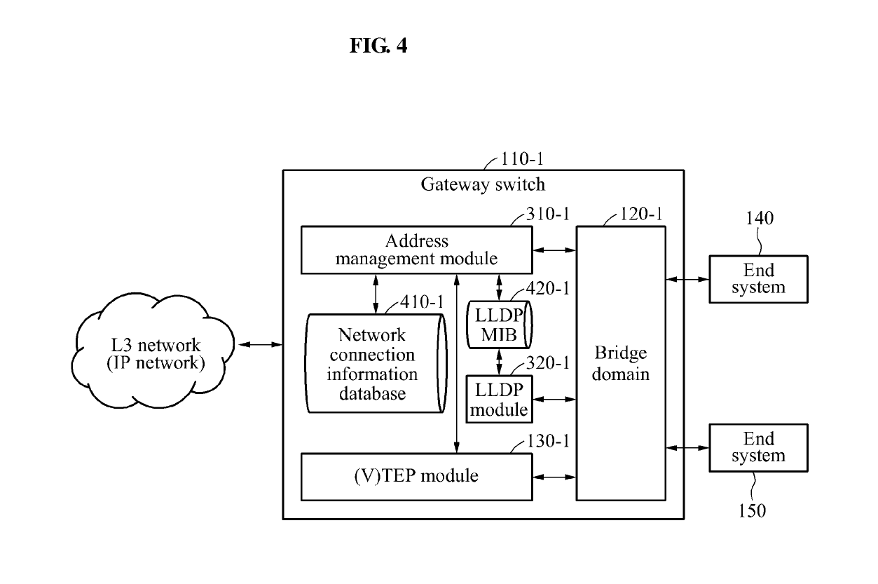

Descriptions pertaining to a method of managing the network connection information database by the address management module 310-1 will be provided further with reference to FIGS. 4 through 7.

The VTEP module 130-1 searches for an MAC address of another end system indicated by an ARP packet received from the end system 140 or 150 based on MAC addresses and/or IP addresses of end systems managed by the address management module 310-1. The VTEP module 130-1 transmits a proxy response packet to the end system 140 or 150 that transmits the ARP packet using the found MAC address.

Further descriptions pertaining to the method of processing the ARP packet by the gateway switch 110-1 will be provided with reference to FIGS. 4 through 7.

Descriptions pertaining to the gateway switch 110-1 and the constituents of the gateway switch 110-1 may be applied to the gateway switch 110-2 and the constituents of the gateway switch 110-2.

Since the technical features described with reference to FIGS. 1 and 2 may be directly applicable here, a detailed description will be omitted for conciseness.

FIG. 4 is a diagram illustrating a gateway switch 110-1 according to an embodiment of the present invention.

The gateway switch 110-1 illustrated in FIG. 4 corresponds to the gateway switch 110-1 previously described with reference to FIG. 3.

Referring to FIG. 4, the gateway switch 110-1 includes a network connection information database 410-1 and an LLDP management information base (MIB) 420-1.

The network connection information database 410-1 stores at least one network connection information of the end systems 140 and 150 of the gateway switch 110-1, end systems of other gateway switches, and end systems of the cloud network management system 350.

The LLDP MIB 420-1 stores network connection information of the end system 140 and/or 150 received by the LLDP module 320-1.

The network connection information of the end systems of the network connection information database 410-1 is classified based on a VNI for each of the end systems.

The network connection information management database 410-1 and the LLDP MIB 420-1 are managed by the address management module 310-1. For example, the address management module 310-1 manages the network connection information of the end systems stored in the network connection information database 410-1 and the LLDP MIB 420-1. The address management module 310-1 manages the network connection information of the end systems based on a VNI for each of the end systems.

Although not illustrated, the network connection information database 410-1 may include the LLDP MIB 420-1.

The VTEP module 130-1 searches for an MAC address of another end system indicated by an ARP packet received from the end system 140 or 150 based on MAC addresses and/or IP addresses of the end systems in the network connection information database 410-1 and the LLDP MIB 420-1 managed by the address management module 310-1. The VTEP module 130-1 transmits a proxy response packet to the end system 140 or 150 that transmits the ARP packet using the found MAC address.

Descriptions pertaining to the gateway switch 110-1 and the constituents of the gateway switch 110-1 may be applied to the gateway switch 110-2 and the constituents of the gateway switch 110-2.

Since the technical features described with reference to FIGS. 1 through 3 may be directly applicable here, a detailed description will be omitted for conciseness.

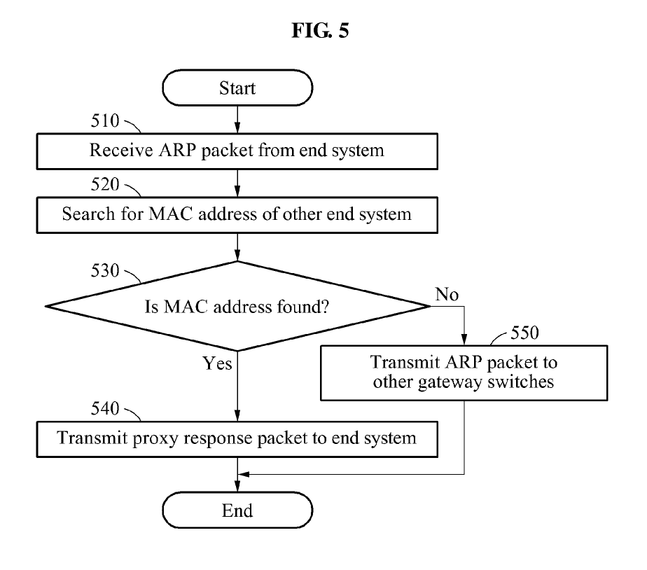

FIG. 5 is a flowchart illustrating a method of processing an ARP packet according to an embodiment of the present invention.

Referring to FIG. 5, the method of processing the ARP packet transmitted to the gateway switch 110-2 by the gateway switch 110-1 previously described with reference to FIGS. 3 and 4 will be described.

In operation 510, the bridge domain 120-1 receives an ARP packet from an end system of the gateway switch 110-1. For example, the end system of the gateway switch 110-1 may correspond to one of the end systems 140 and 150 connected to the gateway switch 110-1 via an L2 network. The end system 140 transmits an ARP packet to the bridge domain 120-1 to communicate with an end system of another gateway switch. By way of example, an ARP packet transmitted from the end system may be a broadcast-based ARP packet used to obtain an MAC address of another end system with which the end system desires to communicate.

The ARP packet received by the bridge domain 120-1 is transmitted to the VTEP module 130-1.

In operation 520, the VTEP module 130-1 searches for an MAC address of another end system that the end system of the gateway switch 110-1 desires to obtain through an ARP packet. In one example, the other end system may refer to a target end system with which the end system of the gateway switch 110-1 desires to communicate. In this example, the VTEP module 130-1 searches for an MAC address of the target end system indicated by the received ARP packet.

In another example, the other end system may refer to an end system of the other gateway switch 110-2 or an end system of the cloud network management system 350 connected to the gateway switch 110-1 via an L3 network.

The VTEP module 130-1 searches for an MAC address based on the network connection information database 410-1 of the gateway switch 110-1. For example, the network connection information database 410-1 may be used to search for an MAC address of another end system that an end system desires to obtain through an ARP packet received from the end system of the gateway switch 110-1.

The network connection information database 410-1 of the gateway switch 110-1 may be a database of network connection information divided based on a network identifier of at least one other end system of the cloud network management system 350 connected to the gateway switch 110-1 or at least one other end system of gateway switches connected to the gateway switch 110-1. For example, network connection information of end systems of the network connection information database 410-1 may be divided based on a VNI for each of the end systems.

The network connection information database 410-1 includes at least one of an MAC address and an IP address of the at least one other end system of the cloud network management system 350 connected to the gateway switch 110-1 or the at least one other end system of the gateway switches connected to the gateway switch 110-1 as network connection information of the other end system.

The network connection information database 410-1 is managed by the address management module 310-1. The VTEP module 130-1 searches for an MAC address of a target end system indicated by an ARP packet received in the network connection information database 410-1 managed by the address management module 310-1. Alternatively, the VTEP module 130-1 searches for the MAC address of the target end system indicated by the received ARP packet in the network connection information database 410-1 through the address management module 310-1.

In operation 530, the VTEP module 130-1 determines whether the MAC address of the other end system indicated by the received ARP packet existing in the network connection information database 410-1.

When the MAC address of the other end system is not found, the VTEP module 130-1 transmits the ARP packet to the cloud network management system 350 connected to the gateway switch 110-1 or the gateway switches connected to the gateway switch 110-1 in operation 550 because the MAC address of the other end system indicated by the received ARP packet is absent in the network connection information database 410-1. The ARP packet transmitted to the cloud network management system 350 or the gateway switches is transmitted via the L3 network. A target IP address of the ARP packet transmitted to the cloud network management system 350 or the gateway switches may be a multicast address assigned to the end system of the gateway switch 110-1, a multicast address or a broadcast address assigned to a multicast group corresponding to a VNI of the end system of the gateway switch 110-1. When the MAC address of the other end system is found, the VTEP module 130-1 transmits a proxy response packet in response to the ARP packet to the end system of the gateway switch 110-1 that transmits the ARP packet because the MAC address of the other end system indicated by the received ARP packet exists in the network connection information database 410-1. An ARP table of the end system that receives the proxy response packet is updated based on the received proxy response packet. For example, the

ARP table of the end system is updated through the MAC address of the other end system included in the received proxy response packet being registered. The proxy response packet may be a response ARP packet in response to the ARP packet including the MAC address of the other end system. The VTEP module 130-1 transmits the proxy response packet to the end system through the bridge domain 120-1.

The ARP packet or the response ARP packet may not flood the other gateway switches and/or the cloud network management system 350 via the L3 network, and an overload of the L3 network may be reduced through the proxy response packet in response to the ARP packet being transmitted to the end system by the VTEP module 130-1. Since the technical features described with reference to FIGS. 1 through 4 may be directly applicable here, a detailed description will be omitted for conciseness.

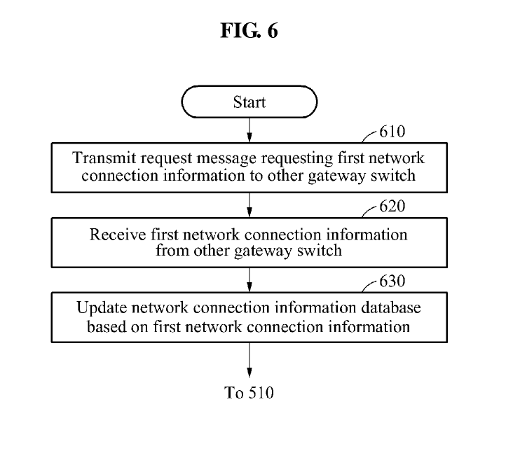

FIG. 6 is a flowchart illustrating a method of updating a network connection information database 410-1 according to an embodiment of the present invention.

The method of updating the network connection information database 410-1 previously described with reference to FIGS. 4 and 5 will be described hereinafter referring to FIG. 6. The network connection information database 410-1 includes at least one of an

MAC address and an IP address of at least one other end system of the cloud network management system 350 connected to the gateway switch 110-1 or at least one other end system of gateway switches connected to the gateway switch 110-1 as network connection information of the other end system. The network connection information database 410-1 includes at least one of an MAC address and an IP address of at least one end system of the gateway switch 110-1 as network connection information of the end system.

In operation 610, the VTEP module 130-1 transmits a request message requesting first network connection information to the cloud network management system 350 or at least one other gate switch from among gate switches connected to the gateway switch 110-1. The first network connection information requested from the VTEP module 130-1 through the request message may be network connection information including at least one of an MAC address and an IP address of at least one end system of the other gateway switch or at least one end system of the cloud network management system 350. The request message transmitted from the VTEP module 130-1 includes second network connection information of the at least one end system of the gateway switch 110-1. For example, the second network connection information may be network connection information including at least one of an MAC address and an IP address of the at least one end system of the gateway switch 110-1. The VTEP module 130-1 transmits the network connection information of the at least one end system of the gateway switch 110-1 to the other gateway switch and/or the cloud network management system 350.

Although not illustrated, the VTEP module 130-1 may transmit the network connection information of the at least one end system of the gateway switch 110-1 to the other gateway switch and/or the cloud network management system 350 as additional data aside from the request message.

In operation 620, the VTEP module 130-1 receives the first network connection information from the other gateway switch or the cloud network management system 350 to which the request message of operation 610 is transmitted.

Through operations 610 and 620, the gateway switch 110-1 and the other gateway switch or the cloud network management system 350 exchange network connection information one another. The gateway switch and the cloud network management system 350 identify MAC addresses and/or IP addresses of end systems of the other gateway switch and/or the cloud network management system 350 through the received network connection information.

The transmitting of the request message and the receiving of the first network connection information in operations 610 and 620 are performed via an L3 network connecting the gateway switches and the cloud management network system 350.

The transmitting of the request message and the receiving of the first network connection information in operations 610 and 620 are performed through a multicast tunnel or a unicast tunnel.

In operation 630, the address management module 310-1 updates the network connection information database 410-1 based on the first network connection information received in operation 620.

Through the exchanging of the network connection information amongst the gateway switch 110-1 and the other gateway switch or the cloud network management system 350 one another in operations 610 and 620, a network connection information database of the other gateway switch or the cloud network management system 350 may be updated based on the exchanged network connection information.

The transmitting of the request message and the receiving of the first network connection information in operations 610 and 620 are performed at predetermined intervals. Also, the updating of the network connection information database 410-1 in operation 630 is performed at predetermined intervals.

The VTEP module 130-1 searches for the MAC address of the other end system in operation 520 based on the network connection information database 410-1 updated in operation 630.

The cloud virtual machine management system 360 statically updates and manages ARP tables of the end systems of the cloud network management system 350 based on network connection information of end systems received from at least one gateway switch. For example, the ARP tables of the end systems of the cloud network management system 350 are updated without receiving a broadcast-based ARP packet via the L3 network from the end systems of the at least one gateway switch.

Since the technical features described with reference to FIGS. 1 through 5 may be directly applicable here, a detailed description will be omitted for conciseness.

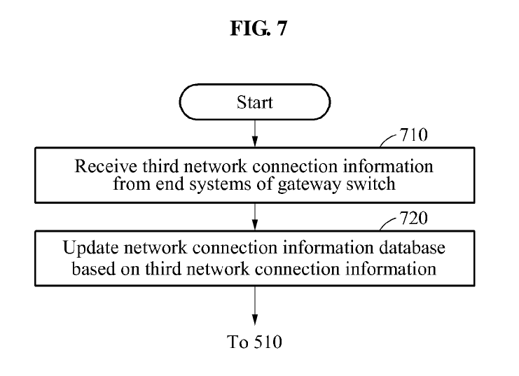

FIG. 7 is a flowchart illustrating a method of updating a network connection information database 410-1 according to an example of the present invention.

Referring to FIG. 7, the method of updating the network connection information database 410-1 previously described with reference to FIGS. 4 through 6 will be described.

In operation 710, the the LLDP module 320-1 receives third network connection information of end systems from at least one end system through the bridge domain 120-1. The third network connection information is network connection information including at least one of an MAC address and an IP address of an end system of the gateway switch 110-1. The third network connection information is an LLDP packet transmitted through an LLDP.

The LLDP module 320-1 receives the third network connection information as the LLDP packet at predetermined intervals through the LLDP.

The LLDP module 320-1 stores the received third network information in the LLDP MIB 420-1. The third network connection information stored in the LLDP MIB 420-1 is managed by the address management module 310-1.

In operation 720, the address management module 310-1 updates the network information database 410-1 based on the received third network connection information.

For example, the address management module 310-1 updates the network information database 410-1 at predetermined intervals through the third network connection information being received at predetermined intervals. Alternatively, the address management module 310-1 updates the LLDP MIB 420-1 based on the received third network connection information. The LLDP MIB 420-1 is included in the network information database 410-1.

The address management module 310-1 manages MAC addresses and/or IP addresses of end systems of the gateway switch 110-1 through the third network connection information being managed by the address management module 310-1.

Although not illustrated, operation 720 may correspond to operation 630 previously described with reference to FIG. 6. For example, in operation 630, the address management module 310-1 updates the network connection information database 410-1 based on the first network connection information received in operation 620 and the third network connection information received in operation 710.

The VTEP module 130-1 searches for an MAC address of another end system in operation 520 based on the network connection information database 410-1 updated in operation 720.

Since the technical features described with reference to FIGS. 1 through 6 may be directly applicable here, a detailed description will be omitted for conciseness.

According to an aspect of the present exemplary embodiment, there is provided a method and an apparatus for processing an ARP packet that reduces an overload of an L3 network occurring due to flooding of an ARP packet by transmitting a proxy response packet to an end system that transmits the ARP packet.

According to an aspect of the present exemplary embodiment, there is provided a method of managing a network connection information database that efficiently manages network connection information of end systems by receiving the network connection information of the end systems from gateway switches and/or a cloud network management system through a unicast tunnel or a multicast tunnel.

The units described herein may be implemented using hardware components, software components, or a combination thereof. For example, a processing device may be implemented using one or more general-purpose or special purpose computers, such as, for to example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software.

For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such to as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of processing an address resolution protocol (ARP) packet performed by a gateway switch, the method comprising:
receiving an ARP packet from an end system of the gateway switch;
searching for a media access control (MAC) address of another end system that the end system desires to obtain through the received ARP packet; and
transmitting a proxy response packet with respect to the ARP packet to the end system when the MAC address of the other end system is found.

2. The method of claim 1, wherein the searching comprises:
searching for the MAC address based on a network connection information database of the gateway switch.

3. The method of claim 2, wherein the gateway switch is connected to at least one gateway switch and a cloud network management system via a network, and
the network connection information database is a database of a network connection information divided based on a network identifier of at least one other end system of the cloud network management system or at least one other end system of the gateway switch.

4. The method of claim 2, wherein the gateway switch is connected to at least one gateway switch and a cloud network management system via a network, and
the network connection information database comprises at least one of an MAC address and an Internet protocol (IP) address of the cloud network management system or at least one other end system of the gateway switch.

5. The method of claim 2, wherein the gateway switch is connected to at least one gateway switch and a cloud network management system via a network, and further comprises:
transmitting a request message requesting first network connection information to the cloud network management system or at least one other gateway switch from among the at least one gateway switch;
receiving the first network connection information from the other gateway switch or the cloud network management system to which the request message is transmitted; and
updating the network connection information database based on the received first network connection information.

6. The method of claim 5, wherein the transmitting of the request message and the receiving of the first network connection information are performed through a multicast tunnel or a unicast tunnel.

7. The method of claim 5, wherein the request message comprises:
second network connection information of at least one end system of the gateway switch.

8. The method of claim 1, further comprising:
receiving third network connection information of the end system from the end system; and
updating the network connection information database based on the received third network connection information.

9. The method of claim 8, wherein the third network connection information is a link layer discovery protocol (LLDP) packet transmitted through an LLDP.

10. The method of claim 1, wherein an ARP table of the end system is updated based on the transmitted proxy response packet.

11. The method of claim 1, wherein the ARP packet is a broadcast-based packet used to obtain the MAC address of the other end system with which the end system desires to communicate.

12. A method of managing a network connection information database performed by a gateway switch connected to at least one gateway switch and a cloud network management system via a network, the method comprising:
transmitting a request message requesting first network connection information to the cloud network management system or at least one other gateway switch from among the at least one gateway switch, wherein the first network connection information comprises at least one of a media access control (MAC) address and an Internet protocol (IP) address of the cloud network management system or at least one other end system of the gateway switch;
receiving the first network connection information from the cloud network management system or the gateway switch to which the request message is transmitted; and
updating a network connection information database of the gateway switch based on the received first network connection information,
wherein the network connection information database is used to search for an MAC address of another end system that the end system desires to obtain through an address resolution protocol (ARP) packet received from the end system of the gateway switch.

13. The method of claim 12, wherein the transmitting of the request message and the receiving of the first network connection information are performed through a multicast tunnel or a unicast tunnel.

14. The method of claim 12, wherein the request message comprises:
second network connection information of at least one end system of the gateway switch.

15. The method of claim 12, further comprising:
receiving third network connection information of the end system from at least one end system of the gateway switch,
wherein the updating of the network connection information database comprises:
updating the network connection information database based on the received first network connection information and the received third network connection information.

16. A gateway switch comprising:
a bridge domain to receive an address resolution protocol (ARP) packet from an end system of the gateway switch; and
a virtual extensible local area network tunnel end point (VTEP) module to search for a media access control (MAC) address of another end system that the end system desires to obtain through the received ARP packet,
wherein when the MAC address of the other end system is found, the VTEP module transmits a proxy response packet with respect to the ARP packet to the end system through the bridge domain.

17. The gateway switch of claim 16, wherein the gateway switch is connected to at least one gateway switch and a cloud network management system via a network, and
the VTEP module searches for the MAC address based on a network connection information database of the gateway switch, transmits a request message requesting first network connection information to the cloud network management system or at least one other gateway switch from among the at least one gateway switch, and receives the first network connection information from the other gateway switch or the cloud network management system to which the request message is transmitted, and
the gateway switch further comprises an address management module to update the network connection information database based on the received first network connection information.

18. The gateway switch of claim 16, further comprising:
a link layer discovery protocol (LLDP) module,
wherein the LLDP module receives third network connection information of the end system from the end system through the bridge domain, and
the address management module updates the network connection information database based on the received third network connection information.
